(19) United States
(12) Patent Application Publication
(10) Pub. No.: US 2009/0031082 A1
(43) Pub. Date: Jan. 29, 2009

(54) Accessing a Cache in a Data Processing Apparatus

(76) Inventors: Simon Andrew Ford, Cambridge (GB); Mrinmoy Ghosh, Atlanta, GA (US); Emre Ozer, Cambridge (GB); Stuart David Biles, Suffolk (GB)

Correspondence Address: NIXON & VANDERHYE, PC, 901 NORTH GLEBE ROAD, 11TH FLOOR, ARLINGTON, VA, 22203, US

(21) Appl. No.: 12/224,725

(22) PCT Filed: Mar. 6, 2006
(86) PCT No.: PCT/GB2006/000795

§ 371 Date: Sep. 4, 2008

(51) Int. Cl. G06F 12/08; G06F 12/00

(52) U.S. Cl. 711/128; 711/216; 711/E12.001; 711/E12.018; 711/E12.017

(57) ABSTRACT

A data processing apparatus is provided having processing logic for performing a sequence of operations, and a cache having a plurality of segments for storing data values for access by the processing logic. The processing logic is arranged, when access to a data value is required, to issue an access request specifying an address in memory associated with that data value, and the cache is responsive to the address to perform a lookup procedure during which it is determined whether the data value is stored in the cache. Indication logic is provided which, in response to an address portion of the address, provides for each of at least a subject of the segments an indication as to whether the data value is stored in that segment. The indication logic has guardian storage for storing guarding data, and hash logic for performing a hash operation on the address portion in order to reference the guarding data to determine each indication. Each indication indicates whether the data value is either definitely not stored in the associated segment or is potentially stored with the associated segment, and the cache is then operable to use the indications produced by the indication logic to affect the lookup procedure performed in respect of any segment whose associated indication indicates that the data value is definitely not stored in that segment. This technique has been found to provide a particularly power efficient mechanism for accessing the cache.

### FIELD OF THE INVENTION

The present invention relates to techniques for accessing a cache in a data processing apparatus.

### BACKGROUND OF THE INVENTION

A data processing apparatus will typically include processing logic for executing sequences of instructions in order to perform processing operations on data items. The instructions and data items required by the processing logic will generally be stored in memory, and due to the long latency typically incurred when accessing memory, it is known to provide one or more levels of cache within the data processing apparatus for storing some of the instructions and data items required by the processing logic to allow a quicker access to those instructions and data items. For the purposes of the following description, the instructions and data items will collectively be referred to as data values, and accordingly when referring to a cache storing data values, that cache may be storing either instructions, data items to be processed by those instructions, or both instructions and data items. Further, the term data value is used herein to refer to a single instruction or data item, or alternatively to refer to a block of instructions or data items, as for example is the case when referring to a linefill process to the cache.

Significant latencies can also be incurred when cache misses occur within a cache. In the article entitled “Just Say No: Benefits of Early Cache Miss Determination” by G Memik et al, Proceedings of the Ninth International Symposium on High Performance Computer Architecture, 2003, a number of techniques are described for reducing the data access times and power consumption in a data processing apparatus with multi-level caches. In particular, the article describes a piece of logic called a “Mostly No Machine” (MNM) which, using the information about blocks placed into and replaced from caches, can quickly determine whether an access at any cache level will result in a cache miss. The accesses that are identified to miss are then aborted at that cache level. Since the MNM structures used to recognise misses are significantly smaller than the cache structures, data access time and power consumption is reduced.

The article entitled “Bloom Filtering Cache Misses for Accurate Data Speculation and Prefetching” by J Peir et al, Proceedings of the Sixteenth International Conference of Supercomputing, Pages 189 to 198, 2002, describes a particular form of logic used to detect whether an access to a cache will cause a cache miss to occur, this particular logic being referred to as a Bloom filter. In particular, the paper uses a Bloom filter to identify cache misses early in the pipeline of the processor. This early identification of cache misses is then used to allow the processor to more accurately schedule instructions that are dependent on load instructions that are identified as resulting in a cache miss, and to more precisely prefetch data into the cache. Dependent instructions are those which require as a source operand the data produced by the instruction from which they depend, in this example the data being loaded by a load instruction.

The article entitled “Fetch Halting on Critical Load Misses” by N Mehta et al, Proceedings of the 22nd International Conference on Computer Design, 2004, also makes use of the Bloom filtering technique described in the above article by Peir et al. In particular, this article describes an approach where software profiling is used to identify load instructions which are long latency instructions having many output dependencies, such instructions being referred to as “critical” instructions. For any such load instructions, when those instructions are encountered in the processor pipeline, the Bloom filter technique is used to detect whether the cache lookup based on that load instruction will cause a cache miss to occur, and if so a fetch halting technique is invoked. The fetch halting technique suspends instruction fetching during the period when the processor is stalled by the critical load instruction, which allows a power saving to be achieved in the issue logic of the processor.

From the above discussion, it will be appreciated that techniques have been developed which can be used to provide an early indication of a cache miss when accessing data, with that indication then being used to improve performance by aborting a cache access, and optionally also to perform particular scheduling or power saving activities in situations where there are dependent instructions, i.e. instructions that require the data being accessed.

However another issue that arises is, having decided to perform a cache lookup in a cache, how to perform that cache lookup in a power efficient manner. Each way of a cache will typically have a tag array and an associated data array. Each data array consists of a plurality of cache lines, with each cache line being able to store a plurality of data values. For each cache line in a particular data array, the corresponding tag array will have an associated entry storing a tag value that is associated with each data value in the corresponding cache line. In a parallel access cache (often level 1 caches are arranged in this way), when a lookup in the cache takes place, the tag arrays and data arrays are accessed at the same time. Assuming a tag comparison performed in respect of one of the tag arrays detects a match (a tag comparison being a comparison between a tag portion of an address specified by an access request and a tag value stored in an entry of a tag array), then the data value(s) stored in the corresponding cache line of the associated data array are accessed.

One approach taken to seek to improve power efficiency in highly set-associative caches has been to adopt a serial access technique. In such serial access caches (often level 2 caches are arranged in this way), power consumption and cache access time are design trade-offs, because initially only the tag arrays are accessed, and only if the tag comparison performed in respect of a tag array has detected a match is the associated data array then accessed. This is to be contrasted with parallel access caches where the tag arrays and data arrays are accessed at the same time, which consumes more power, but avoids an increase in cache access time. In order to reduce power consumed by reading all data arrays, a serial access procedure can be adopted for highly set-associative caches. Such techniques are described in the articles “SH3: High Code Density, Low Power”, by A. Hasegawa, I. Kawasaki, K. Yamada, S. Yoshioka, S. Kawasaki and P. Biswas, IEEE Micro, 1995, and “The Alpha 21264 Microprocessor”, by R. Kessler, IEEE Micro, 19(2):24-36, April 1999. G. Reinman and B. Calder, in their article “Using a Serial Cache for Energy Efficient Instruction Fetching”, Journal of Systems Architecture, 2004, present a serial access instruction cache that performs tag lookups and then data access in different pipeline stages.

With the emergence of highly associative caches (i.e. having at least 4 ways) a serial access technique may not be sufficient to save cache power. In particular, the energy consumed in performing several tag array lookups in parallel is becoming a major design issue in contemporary microprocessors. With this in mind, several techniques have been proposed for reducing cache tag array lookup energy in highly associative caches. The following is a brief description of such known techniques.

### Way Prediction

B. Calder, D. Grunwald and J. Emer, in their article “Predictive Sequential Associative Cache”, HPCA'96, 1996, propose an early way prediction mechanism that uses a prediction table to predict the cache ways before accessing a level 1 (L1) data cache. The prediction table can be indexed by various prediction sources, for example the effective address of the access.

K. Inoue, T. Ishihara and K. Murakami, in their article “Way-Predicting Set-Associative Cache for High Performance and Low Energy Consumption”, ISLPED, 1999, present a way-predicting L1 data cache for low power where they speculatively predict one of the cache ways for the first access by using the Most Recently Used (MRU) bits for the set. If it does not hit, then a lookup is performed in all the ways.

The articles “Reducing Set-Associative Cache Energy via Way-Prediction and Selective Direct-Mapping”, by M. D. Powell, A. Agarwal, T. N. Vijaykumar, B. Falsafi, and K. Roy, MICRO-34, 2001, and “Reactive Caches”, by B. Batson and T. N. Vijaykumar, PACT'01, 2001, describe using PC-based 2-level prediction tables to predict the L1 data cache ways for improving performance as well as power. An advantage of using PC for prediction is that it is available at an early pipeline stage so that the access to the predictor can be done much earlier than the cache access. However, its accuracy is quite low.

In summary, such way prediction techniques predict for set associative caches which ways are more likely to store the data value the subject of a particular access request, so as to enable the cache lookup to be initially performed in those ways (in some instances only a single way will be identified at this stage). If that lookup results in a cache miss, then the lookup is performed in the other ways of the cache. Provided the prediction scheme can provide a sufficient level of accuracy this can yield power consumption improvements when compared with a standard approach of subjecting all ways to the cache lookup for every access request. However, in the event that the prediction proves wrong, it is then necessary to perform the lookup in all ways, and this ultimately limits the power consumption improvements that can be made.

### Way Storing

The following techniques use an extra storage to store the way information.

Way Memorization as explained in the article “Way Memorization to Reduce Fetch Energy in Instruction Caches”, by Albert Ma, Michael Zhang, Krste Asanovic, Workshop on Complexity Effective Design, July 2001, works for instruction caches since instruction fetch is mostly sequential. A cache line in the instruction cache keeps links to the next line to be fetched. If the link is valid, the next line is fetched without tag comparison. However this scheme requires elaborate link invalidation techniques.

Similarly, the way memorization technique discussed by T. Ishihara and F. Fallah in the article, “A Way Memorization Technique for Reducing Power Consumption of Caches in Application Specific Integrated Processors”, DATE'05, 2005, uses a Memory Address Buffer (MAB) to cache the most recently used addresses, the index and the way. Like in the earlier mentioned way memorization technique, no tag comparison is done if there is a hit in the MAB.

The “location cache” described in the article by R. Min, W.-Ben Jone and Y. Hu, “Location Cache: A Low-power L2 Cache System”, ISLPED'04, August 2004. is an alternative technique to way prediction for level 2 (L2) caches. A small cache that sits at the L1 level stores the way numbers for the L2 cache. When there is a miss in the L1 cache and a location cache hit, the location cache provides the required way number to the L2 cache. Then, only the provided way is accessed as if it is a direct-mapped cache. If the location cache misses, all L2 ways are accessed. The location cache is indexed by the virtual address from the processor and accessed simultaneously with the L1 cache and Table Lookaside Buffer (TLB).

The way determination unit proposed by D. Nicolaescu, A. V. Veidenbaum and A. Nicolau, in their article “Reducing Power Consumption for High-Associativity Data Caches in Embedded Processors”, DATE'03, 2003, sits next to the L1 cache and is accessed before the cache and supplies the way number. It has a fully-associative buffer that keeps the cache address and a way number pair in each entry. Before accessing the L1 cache, the address is sent to the way determination unit which sends out the way number if the address has been previously seen. If not, then all the cache ways are searched.

Such way storing techniques can provide significantly improved accuracy when compared with way prediction techniques, but are expensive in terms of the additional hardware required, and the level of maintenance required for that hardware.

### Way Filtering

The following techniques store some low-order bits from the tag portion of an address in a separate store (also referred to herein as way filtering logic), which is used to provide a safe indication that data is definitely not stored in an associated cache way.

The “sentry tag” scheme described by Y.-Jen Chang, S.-Jang Ruan and F. Lai, in their article “Sentry Tag: An Efficient Filter Scheme for Low Power Cache”, Australian Computer Science Communications, 2002, uses a filter to prevent access to all ways of the cache during an access. It keeps one or more bits from the tag in a separate store called the sentry tag. Before reading the tags, the sentry tag bits for each cache way are read to identify whether further lookup is necessary. Since this scheme uses the last “k” bits of the tag it needs n*k bit comparisons for the sentry tag over the normal cache access, where n is the number of ways.

The way-halting cache described by C. Zhang, F. Vahid, J. Yang and W. Najjar, in their article “A Way-Halting Cache for Low-energy High-performance Systems”, ISLPED'04, August 2004, is quite similar to the above mentioned sentry tag scheme. It splits the tag array into two in a L1 cache. The smaller halt tag array keeps the lower 4 bits of tags in a fully-associative array while the rest of the tag bits are kept in the regular tag array. When there is a cache access, the cache set address decoding and the fully-associative halt tag lookup are performed simultaneously. For a given way, further lookup in the regular tag array is halted if there is no halt tag match at the set pointed to by the cache index. The authors report both performance improvement and energy savings using this technique.

The two level filter cache technique described by Y.-Jen Chang, S.-Jang Ruan and F. Lai in their article “Design and Analysis of Low-power Cache using Two-level Filter Scheme”, IEEE Transactions on Very Large Scale Integration (VLSI) Systems, August 2003, builds on the above mentioned sentry tag scheme. It has two filters with the first filter being the MRU blocks and the second filter being the “sentry tags”.

In the way-selective cache described by J. Park, G. Park, S. Park and S. Kim, in their article “Power-Aware Deterministic Block Allocation for Low-Power Way-Selective Cache Structure”, IEEE International Conference on Computer Design (ICCD'04), 2004, the replacement policy dictates that the four least significant tag bits are different for each cache way in a particular set. These four bits are kept in a mini-tag array. This mini-tag array is used to enable only one way of the data array.

Whilst such techniques can give a definite indication as to when a data value will not be found in a particular cache way, there is still a very high likelihood that an access which has not been discounted by the way filtering logic will still result in a cache miss in the relevant way, given that only a few bits of the tag will have been reviewed by the way filtering logic. Hence, only a small proportion of cache miss conditions will be identified by the way filtering logic, resulting in the overall accuracy being quite low. Furthermore, since the way filtering logic stores bits of the tag portion associated with each cache line, each lookup in the way filtering logic only provides an indication for a particular cache line in a particular way, and hence separate entries are required in the way filtering logic for each cache line. There is hence no flexibility in specifying the size of the way filtering logic, other than choosing the number of tag bits to store for each cache line.

### Software-Based Way Selection

D. Albonesi in the article “Selective Cache Ways: On-demand Cache Resource Allocation”, MICRO-32, November 1999, proposes a software/hardware technique for selectively disabling some of the L1 cache ways in order to save energy. This technique uses software support for analysing the cache requirements of the programs and enabling/disabling the cache ways through a cache way select register. Hence, in this technique, software decides which ways to turn on or off by setting a special hardware register.

Such an approach requires prior knowledge of the cache requirements of programs to be determined, and puts constraints on those programs since the level of power saving achievable will depend on how the program has been written to seek to reduce cache requirements.

It is an aim of the present invention to provide an improved technique for reducing power consumption when performing a cache lookup, which alleviates problems associated with the known prior art techniques.

### SUMMARY OF THE INVENTION

Viewed from a first aspect, the present invention provides a data processing apparatus comprising: processing logic for performing a sequence of operations; a cache having a plurality of segments for storing data values for access by the processing logic, the processing logic being operable when access to a data value is required to issue an access request specifying an address in memory associated with that data value, and the cache being operable in response to the address to perform a lookup procedure during which it is determined whether the data value is stored in the cache; and indication logic operable in response to an address portion of the address to provide, for each of at least a subset of the segments, an indication as to whether the data value is stored in that segment, the indication logic comprising: guardian storage for storing guarding data; and hash logic for performing a hash operation on the address portion in order to reference the guarding data to determine each indication, each indication indicating whether the data value is either definitely not stored in the associated segment or is potentially stored within the associated segment; the cache being operable to use the indications produced by the indication logic to affect the lookup procedure performed in respect of any segment whose associated indication indicates that the data value is definitely not stored in that segment.

In accordance with the present invention, the cache has a plurality of segments, and indication logic is provided which is arranged, for each of at least a subset of those segments, to provide an indication as to whether the data value associated with that address may be found in that segment. In particular, the indication logic performs a hash operation on the address portion in order to reference guarding data to determine each indication. Each indication produced indicates whether the data value is either definitely not stored in the associated segment or is potentially stored within the associated segment. These indications are then used to affect the lookup procedure performed in respect of any segment whose associated indication indicates that the data value is definitely not stored in that segment.

The way in which the lookup procedure can be affected by the indications produced by the indication logic can take a variety of forms. For example, if the lookup procedure is initiated before the indications are produced by the indication logic, then those indications can be fed into the lookup procedure to abort the lookup being performed in respect of any segment whose associated indication indicates that the data value is definitely not stored in that segment. This is due to the fact that, in contrast to the earlier described prediction schemes, the indication produced by the indication logic is a safe indication when indicating that the data value is not in a particular segment, and hence there is no need to continue with the lookup in respect of any such segment. Such an approach can give a good compromise between retaining high performance whilst reducing overall power consumption.

Such an approach may for example be adopted in connection with a parallel access cache, where the lookup in all tag arrays is performed in parallel with the lookups in the data arrays. In such embodiments, the indications produced by the indication logic can be used to abort any data array lookups in respect of segments whose associated indication indicates that the data value is definitely not stored in that segment. Hence, in one such embodiment, the indications produced by the indication logic can be used to disable any data arrays for which the indication logic determines that the data value is definitely not stored therein, thereby saving cache energy that would otherwise be consumed in accessing those data arrays. Through use of such an approach in parallel access caches, the operation of the indication logic can be arranged to have no penalty on cache access time.

However, if reduced power consumption is the main concern, then in an alternative embodiment, the lookup procedure is only performed after the indications have been produced by the indication logic, thereby avoiding the lookup procedure being initiated in respect of any segment whose associated indication indicates that the data value is definitely not stored in that segment. By such an approach, enhanced power savings can be realised, since the lookup procedure is never initiated in respect of any segment whose associated indication indicates that the data value is definitely not stored in that segment. With such an approach, there is a potential performance penalty due to the fact that the indications need to be produced by the indication logic before the lookup procedure is initiated. However, in practice it has been found that the indication logic of the present invention operates very quickly, such that the production of the indications by the indication logic, followed by the initiation of the lookup procedure (typically the selection of the appropriate tag RAM entries in the tag array of the cache) can potentially be performed within a single clock cycle. At worst, the production of the indications by the indication logic would add a clock cycle to the cache access time.

Such an approach may for example be adopted in connection with a serial access cache, where the lookup in all tag arrays is performed in parallel, and thereafter a lookup takes place in respect of any data array for which the tag array lookup identifies a match. In one such embodiment, the indications produced by the indication logic can be used to disable any tag arrays for which the indication logic determines that the data value is definitely not stored in the associated data array, thereby saving cache energy that would otherwise be consumed in accessing those tag arrays. For any disabled tag arrays, the lookup in the associated data array will also be avoided.

It has been found that the present invention enables an improved trade off between power consumption, accuracy, cost, and flexibility. In particular, when compared with the earlier-described way prediction techniques, the present invention provides significantly improved accuracy, and hence results in significantly improved power consumption. In particular, if a prediction scheme gives an incorrect prediction, there is a high overhead in terms of power consumption since at that point the lookup needs to be performed in the rest of the cache. The present invention does not suffer from this problem, due to the fact that any indication produced identifying that the data value is not stored within a segment will always be correct, and hence will always enable the lookup procedure to be aborted, or avoided altogether, in respect of any such segment.

Furthermore, in embodiments of the present invention, the operation of the indication logic takes a fixed period of time, whereas prediction schemes and way storing techniques can have variable timing. Given the fixed timing, improved operational speed and power consumption within the cache can be achieved.

Another benefit of the present invention is that it can indicate the complete absence of data within the cache in some situations, whereas typically way prediction schemes will indicate a presence of data in some portion of the cache. Accordingly, this further produces significant power savings when compared with such way prediction schemes.

When compared with the earlier-described way storing techniques, the technique of the present invention is significantly less costly to implement in terms of both hardware resource needed, and the level of maintenance required. Further, some of the known way storing techniques consume a significant amount of power by performing associative comparisons in the way storing buffers.

When compared with the earlier-described way filtering techniques, the present invention typically yields significantly improved accuracy, due to the present invention applying a hash operation to an address portion in order to reference guarding data to determine each indication. In contrast, the earlier-described way filtering techniques perform a direct comparison between a few bits of the tag portion of an address and the corresponding few bits of a tag value stored in association with each cache line. As a result, such way filtering techniques will only identify a small proportion of cache miss conditions, resulting in the overall accuracy being quite low. Furthermore, such way filtering techniques require separate entries in the way filtering logic to be provided for each cache line, with each lookup in the way filtering logic only providing an indication for a particular cache line in a particular way. As a result, such way filtering techniques are relatively inflexible.

When compared with the earlier-described software-based way selection technique, the approach of the present invention does not require prior knowledge of the cache requirements of programs being executed on the data processing apparatus, and does not put any constraints on those programs. Hence, the present invention provides a much more flexible approach for achieving power consumption savings.

In one embodiment, each time the indication logic operates, it produces indications for only a subset of the segments. However, in one embodiment, the lookup procedure is performed simultaneously in respect of the entirety of the cache, and each operation of the indication logic produces an indication for every segment of the cache. As a result, the lookup procedure can be aborted, or avoided altogether, in respect of any segments whose associated indication indicates that the data value is definitely not stored in that segment, thereby producing significant power consumption savings.

The segments of the cache can take a variety of forms. However, in one embodiment, each segment comprises a plurality of cache lines.

In one embodiment, the cache is a set associative cache and each segment comprises at least part of a way of the cache. In one particular embodiment, each segment comprises a way of the cache, such that the indication logic produces an indication for each way of the cache, identifying whether the data value is either definitely not stored in that way, or is potentially stored within that way.

In an alternative embodiment where the cache is a set associative cache, each segment comprises at least part of a set of the cache. Such an approach may be beneficial in a very highly set-associative cache where there may be a large number of cache lines in each set. In one such embodiment, each set is partitioned into a plurality of segments.

The indication logic can take a variety of forms. However, in one embodiment, the indication logic implements a Bloom filter operation, the guarding data in the guardian storage comprises a Bloom filter counter array for each segment, and the hash logic is operable from the address portion to generate at least one index, each index identifying a counter in the Bloom filter counter array for each segment. Hence, in accordance with this embodiment, a Bloom filter counter array is maintained for each segment, and each counter array can be referenced using the at least one index generated by the hash logic. In one particular embodiment, the hash logic is arranged to generate a single index, since it has been found that the use of a single index rather than multiple indexes does not significantly increase the level of false hits. As used herein, the term “false hit” refers to the situation where the indication logic produces an indication that a data value may potentially be stored within an associated segment, but it later transpires that the data value is not within that segment.

The indication logic can take a variety of forms. However, in one embodiment, the indication logic comprises a plurality of indication units, each indication unit being associated with one of said segments and being operable in response to the address portion to provide an indication as to whether the data value is stored in the associated segment. In one such embodiment, each indication unit comprises guardian storage for storing guarding data for the associated segment. Hence, considering the earlier example where the indication logic implements a Bloom filter operation, the guardian storage of each indication unit may store a Bloom filter counter array applicable for the associated segment.

The guardian storage can take a variety of forms. However, in one embodiment, each guardian storage comprises: counter logic having a plurality of counter entries, each counter entry containing a count value; and vector logic having a vector entry for each counter entry in the counter logic, each vector entry containing a value which is set when the count value in the corresponding counter entry changes from a zero value to a non-zero value, and which is cleared when the count value in the corresponding counter entry changes from a non-zero value to a zero value. In such embodiments, the hash logic is operable to generate from the address portion at least one index, each index identifying a counter entry and associated vector entry. The hash logic is then operable whenever a data value is stored in, or removed from, a segment of the cache to generate from the address portion of the associated address said at least one index, and to cause the count value in each identified counter entry of the counter logic of the associated guardian storage to be incremented if the data value is being stored in that segment or decremented if the data value is being removed from that segment. The hash logic is further operable for at least some access requests to generate from the address portion of the associated address said at least one index, and to cause the vector logic of each of at least a subset of the guardian storages to generate an output signal based on the value in each identified vector entry, the output signal indicating if the data value of the access request is not stored in the associated segment.

The actual incrementing or decrementing of the relevant count value(s) can take place at a variety of times during the storage or removal process. For example, the relevant count value(s) can be incremented at the time of allocating a data value to the cache or at some time later when the actual data value is stored as a result of the linefill procedure. Similarly, the relevant count value(s) can be decremented at the time when a data value has been chosen for eviction or at some later time when the data value is overwritten as part of the linefill process following the eviction.

In accordance with this embodiment, separate counter logic and vector logic are provided within each guardian storage, the counter logic being updated based on data values being stored in, or removed from, the associated segment of the cache. In particular, the hash logic generates from an address portion of an address at least one index, with each index identifying a counter entry. The count values in those counter entries are then incremented if data is being stored in the associated segment or decremented if data is being removed from the associated segment. The corresponding vector entries in the vector logic can then be queried for access requests using that address portion, in order to generate an output signal which indicates if the data value of the access request is not stored in that associated segment.

It should be noted that to generate the output signal indicating if the data value of an access request is not stored in the associated segment, only the vector logic needs to be accessed. The vector logic is typically significantly smaller than the counter logic, and hence by arranging for the vector logic to be accessible separately to the counter logic this enables the output signal to be generated relatively quickly, and with relatively low power. Furthermore, it is typically the case that the counter logic will be updated more frequently than the vector logic, since a vector entry in the vector logic only needs updating when the count value in the corresponding counter entry changes from a zero value to a non-zero value, or from a non-zero value to a zero value. Hence, by enabling the vector logic to be accessed separately to the counter logic, this enables the counter logic to be run at a lower frequency than that at which the vector logic is run, thus producing power savings. Running of the counter logic at a lower frequency is acceptable since the operation of the counter logic is not time critical.

The same hash logic may be used to generate at least one index used to reference both the counter logic and the vector logic. However, in one embodiment, the hash logic comprises: first hash logic associated with the counter logic and second hash logic associated with the vector logic; whenever a data value is stored in, or removed from, a segment of the cache the first hash logic being operable to generate from the address portion of the associated address said at least one index identifying one or more counter entries in the counter logic of the associated guardian storage; and for at least some access requests the second hash logic being operable to generate from the address portion of the associated address said at least one index identifying one or more vector entries in the vector logic of each of at least a subset of the guardian storages. By replicating the hash logic for both the counter logic and the vector logic, this assists in facilitating the placement of the vector logic at a different location within the data processing apparatus to that which the counter logic is located, which provides additional flexibility when designing the indication logic. For example, in one embodiment, the vector logic for each indication unit can be grouped in one location and accessed simultaneously using the same hash logic, whilst the counter logic for each indication unit is then provided separately for reference during linefills to, or evictions from, the associated segment.

In particular, in one embodiment, the data processing apparatus further comprises: matrix storage for providing the vector logic for all indication units; the hash logic being operable for at least some access requests to generate from the address portion of the associated address said at least one index, and to cause the matrix storage to generate a combined output signal providing in respect of each indication unit an indication of whether the data value is either definitely not stored in the associated segment or is potentially stored within the associated segment.

Whilst the hash logic may be provided for the indication logic as a whole, in one embodiment, the hash logic is replicated for each indication unit. In embodiments where the hash logic comprises first hash logic associated with the counter logic and second hash logic associated with the vector logic, then the first hash logic may be replicated for each counter logic and the second hash logic may be replicated for each vector logic. Alternatively, if the vector logic for each indication unit are grouped together, then a single second hash logic can be used. In some embodiments, a single first hash logic could be used for the counter logic of all indication units.

In above embodiments where each guardian storage comprises counter logic and vector logic, it will be appreciated that for an access request each vector logic will produce an output signal indicating if the data value of the access request is not stored in the associated segment. In one such embodiment, the data processing apparatus further comprises lookup control logic operable in response to said output signal from the vector logic of each said guardian storage to abort the lookup procedure in respect of the associated segment if the output signal indicates that the data value is not stored in that segment. As mentioned earlier, in some embodiments the lookup procedure may not be initiated until after the indications have been produced by the indication logic, and in that instance the abortion of the lookup procedure in respect of any segment whose associated output signal indicates that the data value is not stored in that segment may merely involve avoiding the lookup procedure being initiated in respect of any such segment.

The indication logic of embodiments of the present invention may be used in isolation to yield significant power savings when accessing a cache. However, in one embodiment, the data processing apparatus further comprises: prediction logic operable in response to an address portion of the address to provide a prediction as to which of the segments the data value is stored in; the cache being operable to use the indications produced by the indication logic and the prediction produced by the prediction logic to determine which segments to subject to the lookup procedure.

In accordance with such embodiments, the indication logic is used in combination with prediction logic in order to determine which segments to subject to the lookup procedure. The combination of these two approaches can produce further power savings. For example, in one embodiment, the cache is operable to perform the lookup procedure in respect of any one or more segments identified by both the prediction logic and the indication logic as possibly storing the data value, and in the event of a cache miss in those one or more segments the cache being operable to further perform the lookup procedure in respect of any remaining segments identified by the indication logic as possibly storing the data value.

Hence, in such embodiments, rather than straightaway performing the lookup procedure in respect of any segments identified by the indication logic as possibly storing the data value, the lookup procedure is initially performed only in respect of any segments identified by both the prediction logic and the indication logic as possibly storing the data value. If this results in a cache hit, then less power will have been expended in performing the cache lookup. In the event of a cache miss, then the lookup procedure is further performed in respect of any remaining segments identified by the indication logic as possibly storing the data value. This still yields significant power consumption savings when compared with a system which does not use such indication logic, since in such a system it would have been necessary to have performed the lookup in respect of all segments at this point, but by using the indication logic it is likely that a number of the segments will have been discounted by virtue of their associated indication having indicated that the data value is definitely not stored in those segments.

In one embodiment, the cache is operable to ignore the prediction produced by the prediction logic to the extent that prediction identifies any segments that the indication logic has identified as definitely not storing the data value. Hence, through the combined approach of using the indication logic and the prediction logic, a certain level of mispredictions produced by the prediction logic can be ignored, thus avoiding any unnecessary consumption of power. Without the indication logic, such mispredictions would have been acted upon with the resultant cache lookup procedure burning power only to result in a cache miss condition being detected.

In one embodiment, the cache may adopt a serial tag lookup approach in very high associative caches such that not all segments are subjected to the cache lookup procedure at the same time. When performing such a serial cache lookup procedure, the use of the above embodiments of the present invention can yield significant performance improvements, due to the indications produced by the indication logic providing a firm indication as to those segments in which the data value is definitely not stored, thereby avoiding any such segments being subjected to the lookup procedure. This can hence significantly reduce the average cache access time when adopting such a serial tag lookup approach.

In one such serial tag lookup embodiment, the data processing apparatus further comprises: arbitration logic operable, if the indication logic produces indications indicating that the data value is potentially stored in multiple segments, to apply arbitration criteria to select one of said multiple segments; the cache being operable to perform the lookup procedure in respect of the segment selected by the arbitration logic; in the event that that lookup procedure results in a cache miss, a re-try process being invoked to cause the arbitration logic to reapply the arbitration criteria to select an alternative segment from the multiple segments and the cache to re-perform the lookup procedure in respect of that alternative segment, the re-try process being repeated until a cache hit occurs or all of the multiple segments have been subjected to the lookup procedure.

Such an approach may be particularly beneficial in very highly set-associative caches, where as described earlier each segment of the cache may be arranged to comprise part of a set of the cache. In such instances, the arbitration logic may arbitrate between multiple segments in the same set which have been indicated as potentially storing the data value. This hence enables the hardware provided for performing the lookup procedure to be shared between multiple segments, thereby reducing cost.

In embodiments where prediction logic is also provided, the arbitration criteria applied by the arbitration logic may take into account the prediction provided by the prediction logic, which hence enables prioritisation to be made amongst the various segments that need arbitrating based on the indications provided by the indication logic. This can achieve yet further power savings when compared with an alternative approach, where for example the arbitration criteria may apply sequential or random ordering in order to select from among the multiple segments.

Viewed from a second aspect, the present invention provides a cache for storing data values for access by processing logic of a data processing apparatus, for an access request specifying an address in memory associated with a data value required to be accessed by the processing logic, the cache being operable to perform a lookup procedure during which it is determined whether the data value is stored in the cache, the cache comprising: a plurality of segments for storing the data values, and indication logic operable in response to an address portion of the address to provide, for each of at least a subset of the segments, an indication as to whether the data value is stored in that segment, the indication logic comprising: guardian storage for storing guarding data; and hash logic for performing a hash operation on the address portion in order to reference the guarding data to determine each indication, each indication indicating whether the data value is either definitely not stored in the associated segment or is potentially stored within the associated segment; the cache being operable to use the indications produced by the indication logic to affect the lookup procedure performed in respect of any segment whose associated indication indicates that the data value is definitely not stored in that segment.

Viewed from a third aspect, the present invention provides a method of accessing a cache used to store data values for access by processing logic of a data processing apparatus, the cache having a plurality of segments for storing the data values, the method comprising: for an access request specifying an address in memory associated with a data value required to be accessed by the processing logic, performing a lookup procedure during which it is determined whether the data value is stored in the cache; in response to an address portion of the address, employing indication logic to provide, for each of at least a subset of the segments, an indication as to whether the data value is stored in that segment, by: storing guarding data; and performing a hash operation on the address portion in order to reference the guarding data to determine each indication, each indication indicating whether the data value is either definitely not stored in the associated segment or is potentially stored within the associated segment; and using the indications produced by the indication logic to affect the lookup procedure performed in respect of any segment whose associated indication indicates that the data value is definitely not stored in that segment.

### BRIEF DESCRIPTION OF THE DRAWINGS

The present invention will be described further, by way of example only, with reference to embodiments thereof as illustrated in the accompanying drawings, in which:

FIG. 1 is a block diagram of a data processing apparatus in accordance with one embodiment of the present invention;

FIG. 2 is a block diagram of a cache and associated indication logic in accordance with one embodiment of the present invention;

FIG. 3 illustrates an example of a cache lookup operation using the logic of FIG. 2;

FIG. 4 is a block diagram of the indication logic in accordance with one embodiment of the present invention;

FIG. 5 is a block diagram of the indication logic in accordance with an alternative embodiment of the present invention;

FIG. 6 is a diagram schematically illustrating the operation of the hash function illustrated in FIG. 5 in accordance with one embodiment;

FIG. 7 is a block diagram of a cache and associated indication logic in accordance with an alternative embodiment of the present invention;

FIG. 8 is a block diagram of a cache and associated indication logic in accordance with an alternative embodiment of the present invention;

FIG. 9 illustrates an example of a cache lookup operation using the logic of FIG. 8;

FIG. 10 is a block diagram illustrating the indication logic and the tag RAM portion of a cache in accordance with an alternative embodiment of the present invention;

FIG. 11 illustrates an example of a cache lookup operation using the logic of FIG. 10; and

FIG. 12 is a chart illustrating for various types of set associative cache the average number of ways that need to be subjected to a lookup procedure when using the logic of FIG. 2.

### DESCRIPTION OF EMBODIMENTS

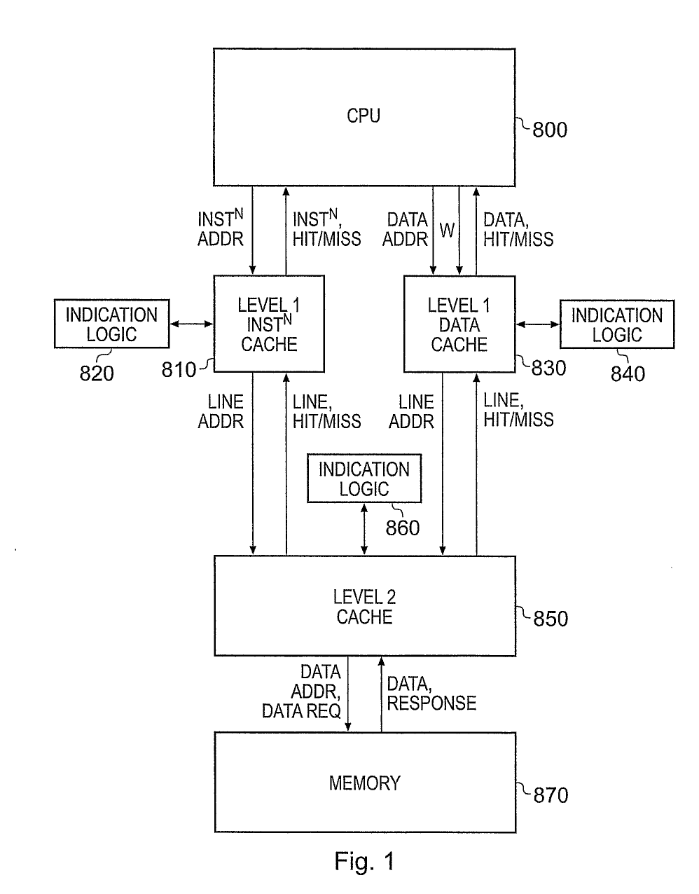

FIG. 1 is a block diagram of a data processing apparatus in accordance with one embodiment. In particular, a processor in the form of a central processing unit (CPU) 800 is shown coupled to a memory hierarchy consisting of level one instruction and data caches 810, 830, a unified level two cache 850, and bulk memory 870. When fetch logic within the CPU 800 wishes to retrieve an instruction, it issues an access request identifying an instruction address to the level one instruction cache 810. If the instruction is found in that cache, then this is returned to the CPU 800, along with a control signal indicating that there has been a hit. However, if the instruction is not in the cache, then a miss signal is returned to the CPU, and the appropriate address for a linefill to the level one instruction cache 810 is output to the level two cache 850. If there is a hit in the level two cache, then the relevant line of instructions is returned to the level one instruction cache 810 along with a control signal indicating a hit in the level two cache. However, if there is a miss in the level two cache 850, then a miss signal is returned to the level one instruction cache 810, and the line address is propagated from the level two cache 850 to memory 870. This will ultimately result in the line of instructions being returned to the level two cache 850 and propagated on to the CPU 800 via the level one instruction cache 810.

Similarly, when execution logic within the CPU 800 executes a load or a store instruction, the address of the data to be accessed will be output from the execution logic to the level one data cache 830. In the event of a store operation, this will also be accompanied by the write data to be stored to memory. The level one data cache 830 will issue a hit/miss control signal to the CPU 800 indicating whether a cache hit or a cache miss has occurred in the level one data cache 830, and in the event of a load operation which has hit in the cache will also return the data to the CPU 800. In the event of a cache miss in the level one data cache 830, the line address will be propagated on to the level two cache 850, and in the event of a hit the line of data values will be accessed in the level two cache. For a load this will cause the line of data values to be returned to the level one data cache 830 for storing therein. In the event of a miss in the level two cache 850, the line address will be propagated on to memory 870 to cause the line of data to be accessed in the memory.

Each of the caches can be considered as having a plurality of segments, and in accordance with the embodiment described in FIG. 1 indication logic can be provided in association with one or more of the caches to provide indications indicating whether the data value the subject of an access request is either definitely not stored in a particular segment or is potentially stored within that segment. In FIG. 1, indication logic 820, 840, 860 are shown in association with each cache 810, 830, 850, but in alternative embodiments the indication logic may be provided in association with only a subset of the available caches.

Whilst for ease of illustration the indication logic 820, 840, 860 is shown separately to the associated cache 810, 830, 850, respectively, in some embodiments the indication logic will be incorporated within the associated cache itself for reference by the cache control logic managing the lookup procedure in the relevant cache.

As will be discussed in more detail later, for each segment that the indication logic is to produce an indication in respect of, the indication logic is arranged to store guarding data for that segment, and further comprises hash logic which performs a hash operation on a portion of the address in order to reference that guarding data so as to determine the appropriate indication to output. Each indication will indicate whether the data value is either definitely not stored in the associated segment or is potentially stored within the associated segment. Hence, for an instruction address output by the CPU 800 to the level one instruction cache 810, the indication logic 820 will perform a hash operation on a portion of that instruction address in order to reference the guarding data for each segment, and based thereon produce indications for each segment identifying whether the associated instruction is either definitely not stored in that segment of the level one instruction cache or is potentially stored within that segment. The indication logic 840 associated with the level one data cache 830 will perform a similar operation in respect of any data address output by the CPU 800 to the level one data cache 830. Similarly, the indication logic 860 will perform an analogous operation in respect of any line address output to the level two cache 850 from either the level one instruction cache 810 or the level one data cache 830.

The guarding data stored in respect of each segment is updated based on eviction and linefill information in respect of the associated segment. In one embodiment, each indication logic uses a Bloom filter technique and maintains guarding data which is updated each time a data value is stored in, or removed from, the associated segment of the relevant cache, based on replacement and linefill information routed to the indication logic from that segment. More details of an embodiment of the indication logic will be discussed in detail later.

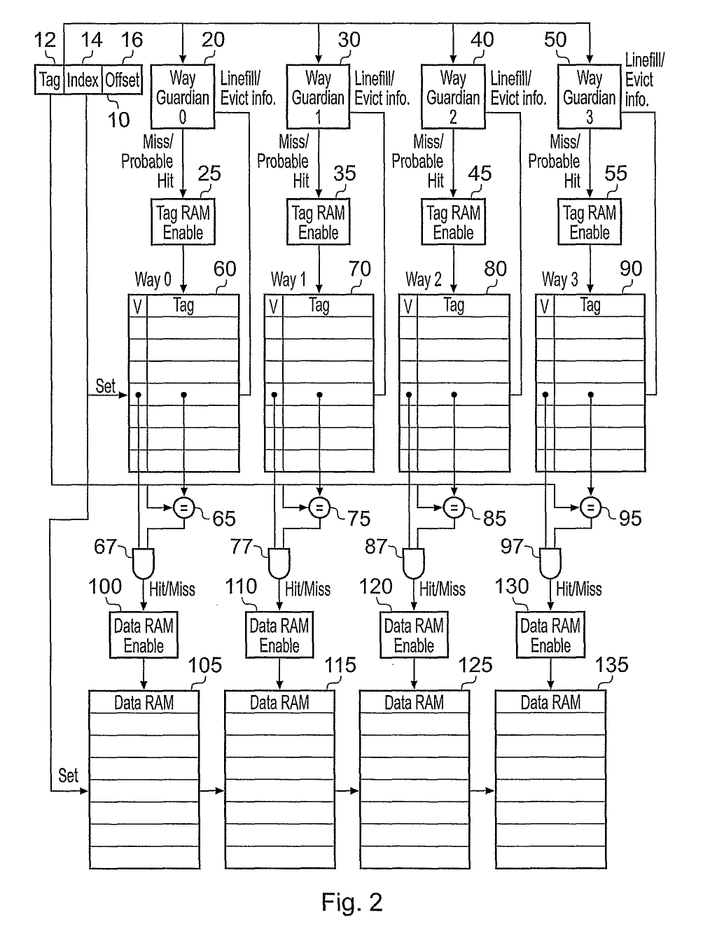

FIG. 2 is a diagram illustrating a cache and associated indication logic in accordance with one embodiment of the present invention. In this embodiment, a four way set associative cache is shown, each way having a tag array 60, 70, 80, 90 and an associated data array 105, 115, 125, 135, respectively. Each data array consists of a plurality of cache lines, with each cache line being able to store a plurality of data values. For each cache line in a particular data array, the corresponding tag array will have an associated entry storing a tag value that is associated with each data value in the corresponding cache line, and a valid field indicating whether the corresponding cache line is valid. As will be appreciated by those skilled in the art, certain other fields may also be provided within the tag array, for example to identify whether the corresponding cache line is clean or dirty (a dirty cache line being one whose contents are more up-to-date than the corresponding data values as stored in memory, and hence which when evicted from the cache will require an update procedure to be invoked to write the values back to memory, assuming the cache line is still valid at that time).

The address 10 associated with a memory access request can be considered to comprise a tag portion 12, an index portion 14 and an offset portion 16. The index portion 14 identifies a particular set within the set associative cache, a set comprising of a cache line in each of the ways. Accordingly, for the four way set associative cache shown in FIG. 1, each set has four cache lines.

A lookup procedure performed by the cache on receipt of such an address 10 will typically involve the index 14 being used to identify an entry in each tag array 60, 70, 80, 90 associated with the relevant set, with the tag data in that entry being output to associated comparator logic 65, 75, 85, 95, which compares that tag value with the tag portion 12 of the address 10. The output from each comparator 65, 75, 85, 95 is then routed to associated AND logic 67, 77, 87, 97, which also receive as their other input the valid bit from the relevant entry in the associated tag array. Assuming the relevant entry indicates a valid cache line, and the comparator detects a match between the tag portion 12 and the tag value stored in that entry of the tag array, then a hit signal (in this embodiment a logic one value) will be output from the relevant AND logic to associated data RAM enable circuitry 100, 110, 120, 130. If any hit signal is generated, then the associated data RAM enable logic will enable the associated data array, 105, 115, 125, 135, as a result of which a lookup will be performed in the data array using the index 14 to access the relevant set, and the offset 16 to access the relevant data value within the cache line.

It will be appreciated that for the lookup procedure described above, this would involve accessing all of the tag arrays, followed by an access to any data array for which a hit signal was generated. As discussed earlier, a cache arranged to perform the lookup procedure in this manner is referred to as a serial access cache. In accordance with embodiments of the present invention, a power saving is achieved in such caches by providing indication logic which in the embodiment of FIG. 2 comprises a series of way guardian logic units 20, 30, 40, 50, one way guardian logic unit being associated with each way of the cache. The construction of the way guardian logic will be described in more detail later, but its basic operation is as follows. Within the way guardian logic unit, guarding data is stored, which is updated based on linefill and eviction information pertaining to the associated way. Then, each time an access request is issued, the tag portion 12 and index portion 14 of the address 10 are routed to each of the way guardian logic units 20, 30, 40, 50, on receipt of which a hash operation is performed in order to generate one or more index values used to reference the guarding data. This results in the generation of an indication which is output from each way guardian logic unit 20, 30, 40, 50, to associated tag RAM enable circuits 25, 35, 45, 55.

Due to the nature of the guarding data retained by the way guardian logic units 20, 30, 40, 50, each indication generated indicates whether the data value the subject of the access request is either definitely not stored in the associated segment or is potentially stored within the associated segment. Hence, as indicated in FIG. 2, the output from each way guardian logic unit 20, 30, 40, 50 will take the form of a miss signal or a probable hit signal. In the event of a miss signal, the associated tag RAM enable circuitry will cause the associated tag array to be disabled, such that the lookup procedure is only performed in respect of those tag arrays for which the associated way guardian logic unit has produced a probable hit signal, thereby causing the associated tag RAM enable circuitry to be enabled.

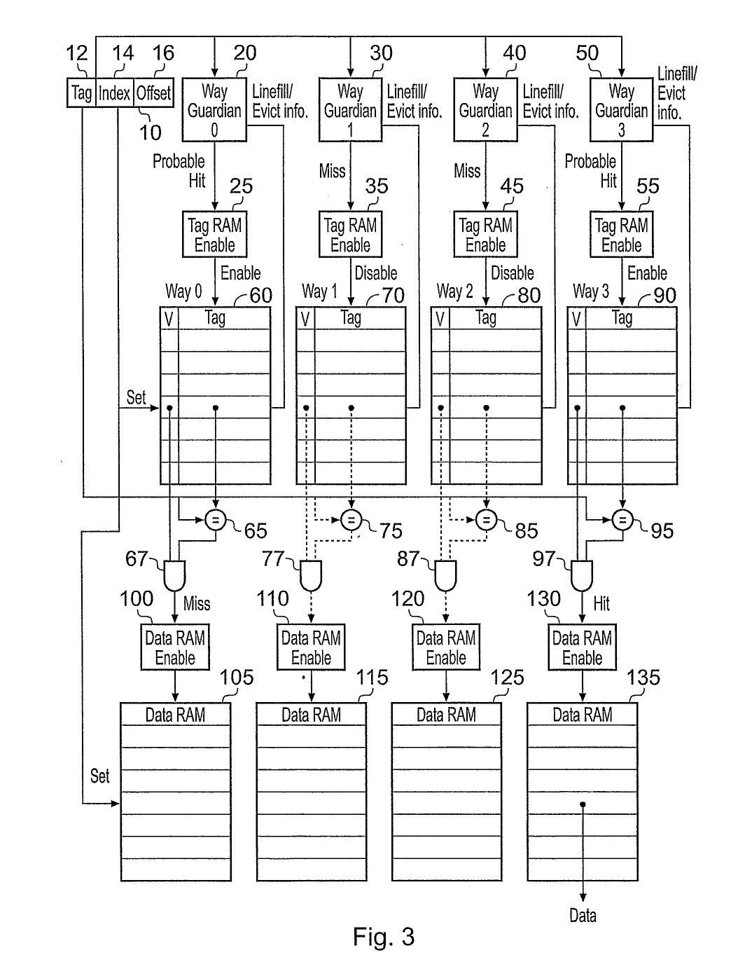

The power savings achievable by such an approach are clear, since instead of having to perform a tag lookup in each tag array, the tag lookup only needs to be performed in a subset of the tag arrays whose associated way guardian logic units have identified a probable hit. A particular example is illustrated in FIG. 3.

The circuitry of FIG. 3 is identical to that of FIG. 2, but in FIG. 3 a particular example is illustrated where the way guardian logic units 20, 50 identify a probable hit, but the way guardian logic units 30, 40 identify a definite miss. In this example, the tag RAM enable circuits 35, 45 disable the associated tag arrays 70, 80, which not only avoids any power consumption being used in accessing those tag arrays, but also avoids any power consumption being used in operating the comparison logic 75, 85 and the associated logic 77, 87. A default logic zero value is in this instance output by the logic 77, 87, which causes the data RAM enable circuits 110 and 120 to disable the associated data arrays 115 and 125.

The probable hit signals generated by the way guardian logic units 20, 50 cause the associated tag RAM enable circuitry 25, 55 to enable the associated tag arrays 60, 90, and hence the earlier described lookup procedure is performed in respect of those two tag arrays. As can be seen from FIG. 3, in this example a miss is detected by the logic 67 in association with the tag array 60, whilst a hit is detected by the logic 97 in association with the tag array 90. Thus, the data RAM enable circuit 100 is disabled and the data RAM enable circuit 130 is enabled, as a result of which a single data array lookup is performed in the data array 135 in order to access a data value identified by the index 14 and offset 16 in the address 10. In this particular example, the cache lookup procedure involves two tag array lookups and one data array lookup, whereas without the use of this embodiment of the present invention the lookup procedure would have involved four tag array lookups and one data array lookup.

Each indication unit within the indication logic 820, 840, 860 of FIG. 1, which in the example of FIG. 2 are shown as way guardian logic units 20, 30, 40, 50, can be implemented in a variety of ways. However, the main purpose of each indication unit is to produce an indication of whether a data value is either definitely not stored in the associated cache segment or may be stored in the associated cache segment, i.e. an indication of a cache segment miss is a safe indication, rather than merely a prediction. In one particular embodiment, each indication unit uses a Bloom filter technique to produce such an indication.

Bloom Filters were named after Burton Bloom for his seminal paper entitled “Space/time trade-offs in hash coding with allowable errors”, Communications of the ACM, Volume 13, Issue 4, July 1970. The purpose was to build memory efficient database applications. Bloom filters have found numerous uses in networking and database applications in the following articles:
A. Border and M. Mitzenmacher, “network application of Bloom Filters: A Survey”, in 40th Annual Allerton Conference on Communication, Control, and Computing, 2002;
S. Rhea and J. Kubiatowicz, “Probabilistic Location and Routing”, IEEE INFOCOM'02, June 2002;
S. Dharmapurikar, P. Krishnamurthy, T. Sproull and J. Lockwood, “Deep Packet Inspection using Parallel Bloom Filters”, IEEE Hot Interconnects 12, Stanford, Calif., August 2003;
A. Kumar, J. Xu, J. Wang, O. Spatschek, L. Li, “Space-Code Bloom Filter for Efficient Per-Flow Traffic Measurement”, Proc. IEEE INFOCOM, 2004;
F. Chang, W. Feng and K. Li, “Approximate Caches for Packet Classification”, IEEE INFOCOM'04, March 2004;
S. Cohen and Y. Matias, “Spectral Bloom Filters”, Proceedings of the 2003 ACM SIGMOD International Conference on Management of Data, 2003; and
L. Fan, P. Cao, J. Almeida, and A. Broder, “Summary cache: A scalable wide-area Web cache sharing protocol,” IEEE/ACM Transactions on Networking, vol. 8, no. 3, pp. 281-293, 2000.

For a generic Bloom filter, a given address portion in N bits is hashed into k hash values using k different random hash functions. The output of each hash function is an m-bit index value that addresses a Bloom filter bit vector of 2^{m}. Here, m is typically much smaller than N. Each element of the Bloom filter bit vector contains only 1 bit that can be set. Initially, the Bloom filter bit vector is zero. Whenever an N-bit address is observed, it is hashed to the bit vector and the bit value hashed by each m-bit index is set.

When a query is to be made whether a given N-bit address has been observed before, the N-bit address is hashed using the same hash functions and the bit values are read from the locations indexed by the m-bit hash values. If at least one of the bit values is 0, this means that this address has definitely not been observed before. If all of the bit values are 1, then the address may have been observed but this cannot be guaranteed. The latter case is also referred to herein as a false hit if it turns out in fact that the address has not been observed.

As the number of hash functions increases, the Bloom filter bit vector is polluted much faster. On the other hand, the probability of finding a zero during a query increases if more hash functions are used.

Recently, Bloom filters have been used in the field of computer micro-architecture. Sethumadhvan et al in the article “Scalable Hardware Memory Disambiguation for High ILP Processors”, Proceedings of the 36th International Symposium for Microarchitecture pp. 399-410, 2003, uses Bloom Filters for memory disambiguation to improve the scalability for load store queues. Roth in the article “Store Vulnerability Window (SVW): Re-Execution Filtering for Enhanced Load Optimization”, Proceedings of the 32^{nd} International Symposium on Computer Architecture (ISCA-05), June 2005, uses a Bloom filter to reduce the number of load re-executions for load/store queue optimizations. Akkary et al in the article “Checkpoint Processing and Recovery: Towards Scalable Large Instruction Window Processors”, Proceedings of the 36th International Symposium for Microarchitecture, December, 2003, also uses a Bloom filter to detect the load-store conflicts in the store queue. Moshovos et al in the article “JETTY: Snoop filtering for reduced power in SMP servers”, Proceedings of International Symposium on High Performance Computer Architecture (HPCA-7), January 2001, uses a Bloom filter to filter out cache coherence requests or snoops in SMP systems.

In the embodiments described herein the Bloom filter technique is employed for the purpose of detecting cache misses in individual segments of a cache. In one particular embodiment, a counting Bloom filter technique is used. The counting Bloom Filter has one counter corresponding to each bit in the bit vector of a normal Bloom Filter. The counting Bloom Filter can be arranged to track addresses entering and leaving an associated cache segment. Whenever there is a line fill in the cache segment, the counters corresponding to the hashes for the address are incremented. In the case of a cache replacement in that segment, the corresponding counters are decremented. If the counter is zero, the address has never been seen before. If the counter is greater than one, the address may have been encountered.

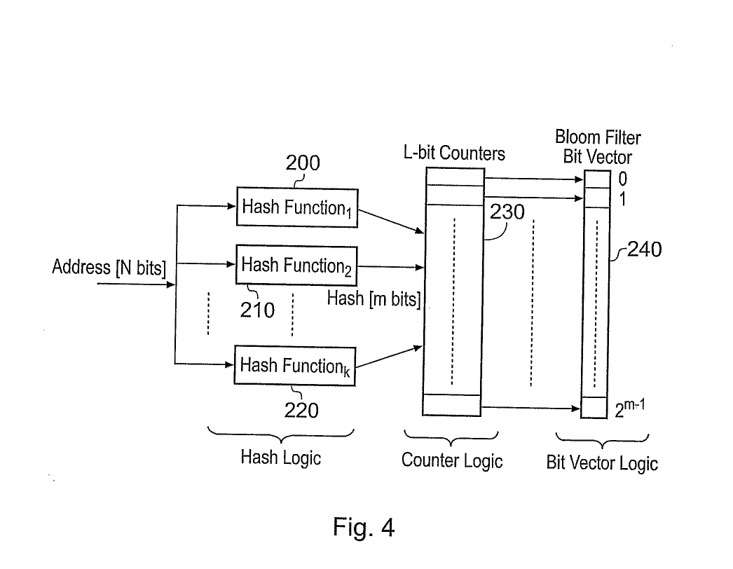

In one particular embodiment, a segmented counting Bloom filter design is used. In accordance with this novel segmented approach, the indication logic has counter logic and separate vector logic as illustrated schematically in FIG. 4. The counter logic 230 has a plurality of counter entries, with each counter entry containing a count value, and the vector logic 240 has a vector entry for each counter entry in the counter logic 230, each vector entry containing a value (preferably a single bit) which is set when the count value in the corresponding counter entry changes from a zero value to a non-zero value, and which is cleared when the count value in the corresponding counter entry changes from a non-zero value to a zero value. Each counter is in one embodiment non-saturating to prevent overflows.

Whenever a data value is stored in, or removed from, the associated cache segment, a portion of the associated address is provided to the hash functions 200, 210, 220, of the hash logic, each of which generates an m-bit index identifying a particular counter in the counter logic 230. The counter value in each identified counter is then incremented if a data value is being stored in the cache segment, or is decremented if a data value is being removed from the cache segment. If more than one hash index identifies the same counter for a given address, the counter is incremented or decremented only once. For certain access requests, the indication logic can then be accessed by issuing the relevant address portion to the hash functions 200, 210, 220 to cause corresponding indexes to be generated identifying particular vector entries in the vector logic 240. If the value in each such vector entry is not set, then this indicates that the data value is not present in the cache, and accordingly a cache segment miss indication can be generated indicating that the data value is not stored in the cache segment. If in contrast any of the vector entries identified by the indexes are set, then the data value may or may not be in the cache segment.

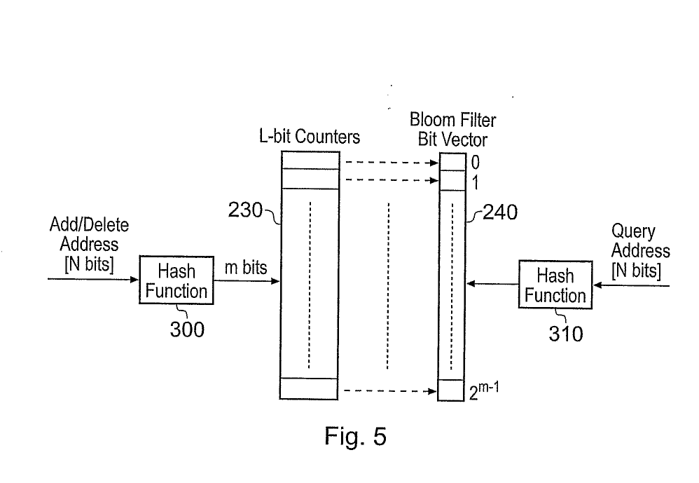

FIG. 5 illustrates an alternative embodiment where separate hash logic is provided for the counter logic 230 and the vector logic 240. Hence, in this embodiment, the hash logic associated with the counter logic 230, in this embodiment the hash logic comprising a single hash function 300, is referenced whenever a data value is stored in, or removed from, the associated cache segment, in order to generate an m-bit index identifying a particular counter in the counter logic 230. Similarly, for certain access requests, where a lookup is required in the cache, the relevant address portion can be routed to the hash logic associated with the bit vector logic 240, in this case the hash logic again comprising a single hash function 310, in order to cause an index to be generated identifying a particular vector entry in the vector logic 240. Typically, the hash functions 300 and 310 are identical.

As illustrated earlier with reference to FIG. 4, multiple hash functions could also be provided in embodiments such as those illustrated in FIG. 5, where separate hash logic is provided for both the counter logic 230 and the vector logic 240, so as to cause multiple counter entries or multiple vector entries to be accessed dependent on each address. However, in one embodiment, only a single hash function is used to form the hash logic used to generate the index into either the counter logic or the vector logic, but as shown in FIG. 5 this hash logic is replicated separately for the counter logic and the vector logic, thereby facilitating placement of the vector logic 240 in a part of the apparatus separate to the counter logic 230.

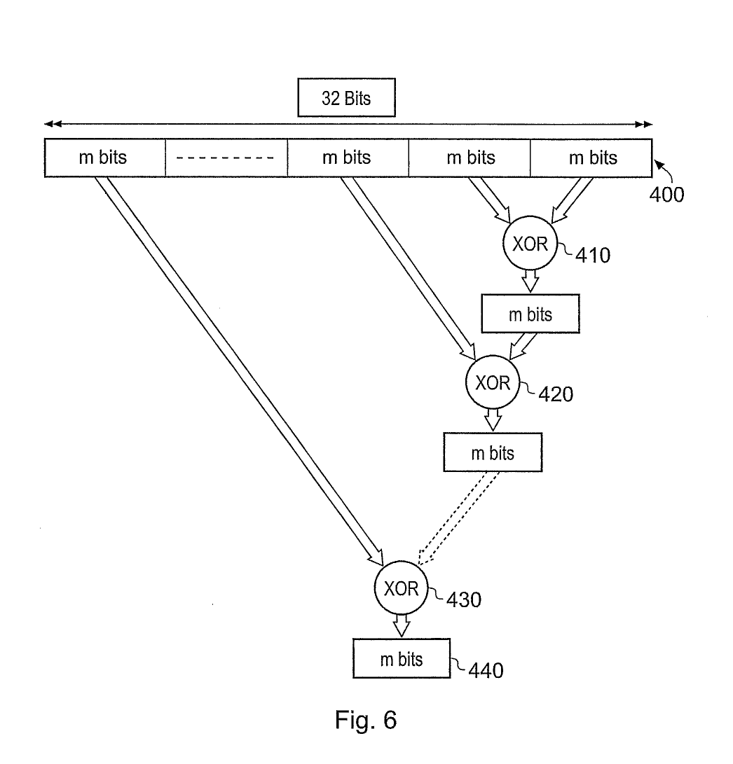

It has been found that having one hash function produces false hit rates similar to the rates achieved when having more than one hash function. The number of bits “L” provided for each counter in the counter logic depends on the hash functions chosen. In the worst case, if all cache lines map to the same counter, the bit-width of the counter must be at most log₂ (# of cache lines in one way of the cache). One form of hash function that can be used in one embodiment involves bitwise XORing of adjacent bits. A schematic of this hash function which converts a 32 bit address to a m bit hash is shown in FIG. 6.

As shown in FIG. 6, each pair of m bits in the address is passed through an XOR function 410, 420, 430 so as to ultimately reduce the address 400 to a single m-bit index 440.

Another simplistic hash function that may be chosen uses the lower log₂ (N) bits of the block address (N is the size of the bloom filter). It can be proven with this hash function that the number of bits per counter is equal to 1 (if N>the number of cache sets). Other simple hash functions could be chosen, such as Hash=Addr % Prime, where Prime is the greatest prime number less than N.

As mentioned earlier, the segmented design provides separate counter logic 230 and bit vector logic 240. There are several benefits realised by such a segmented design. Firstly, to know the outcome of a query to the Bloom filter, only the bit vector logic 240 needs to be accessed, and its size is smaller than the counter logic 230. Keeping the bit vectors separate hence enables faster and lower power accesses to the Bloom Filter. In addition, updates to the counter logic 230 are much more frequent than updates to the bit vector logic 240. Thus segmenting the counter logic and the bit vector logic allows the counter logic to be run at a much lower frequency than the bit vector logic, which is acceptable since the operation of the counter logic is not time critical. In particular, the bit vector logic only needs updating if a particular counter entry in the counter logic changes from a non-zero value to a zero value, or from a zero value to a non-zero value.

Hence, the use of such a segmented design to form each indication unit of the indication logic 820, 840, 860 leads to a particularly efficient approach for generating a segment cache miss indication used to improve power consumption when accessing the cache.

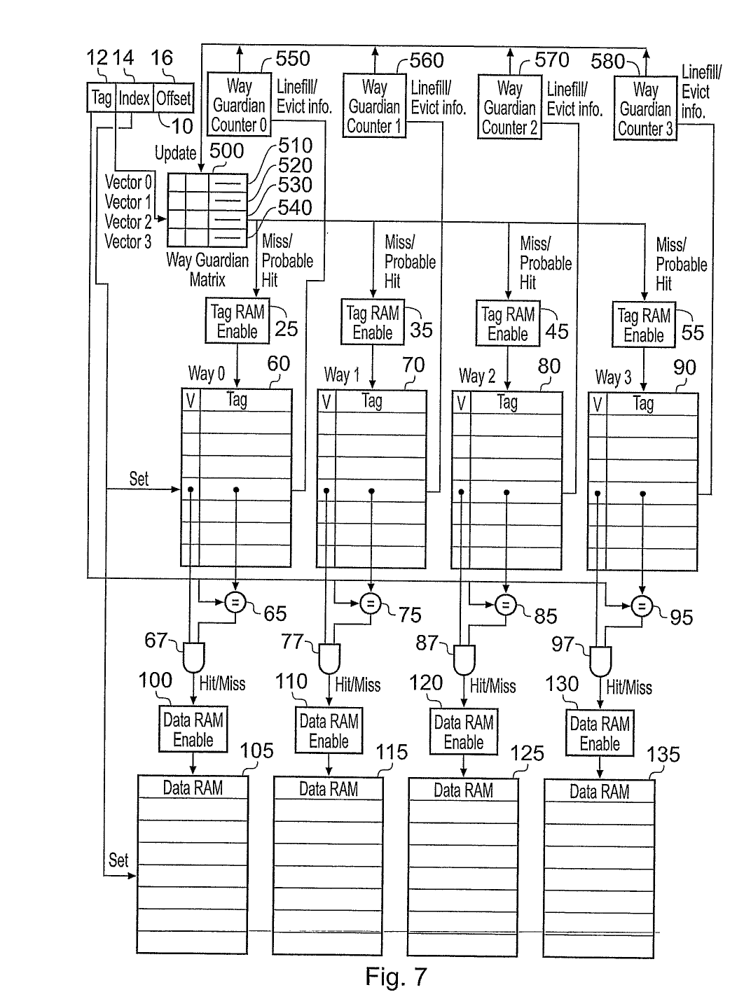

FIG. 7 illustrates an alternative embodiment of a cache and associated indication logic which can be used instead of the arrangement of FIG. 2. As explained earlier, each way guardian logic unit can be implemented by a segmented Bloom filter approach consisting of separate counter logic and bit vector logic. Each way guardian logic unit 20, 30, 40, 50 would use the same hash function(s) to generate the required index or indexes from each address. Thus, given a particular data address 10, all of the way guardian logic units 20, 30, 40, 50 would check at the same index or indexes. Since in one embodiment all of the way guardian logic units are accessed for each address 10, FIG. 7 illustrates an alternative variant, where the vector logic part of each segmented Bloom filter are located together within a matrix storage 500. Hence, as shown in FIG. 7, the matrix 500 will store vector logic 510 associated with way zero, vector logic 520 associated with way one, vector logic 530 associated with way two, and vector logic 540 associated with way three. Separate way guardian counter logic 550, 560, 570, 580 is then maintained in association with each way, with the counters in each counter logic being updated based on the linefill and eviction information from the associated way of the cache. Whenever a particular counter changes from a non-zero value to a zero value or from a zero value to a non-zero value, the corresponding update is made to the relevant bit vector in the matrix 500.

For each address 10, the tag portion 12 and index portion 14 are routed to the way guardian matrix 500 where the hash logic generates one or more indexes (as described earlier in one embodiment only a single hash function will be used and hence only a single index will be generated), which will then be used to access the matrix 500 in order to output for each way a miss or probable hit indication based on the value of the vector entry or vector entries accessed in each bit vector 510, 520, 530, 540 of the matrix 500. From this point on, the operation of the circuit shown in FIG. 7 is as described earlier with reference to FIG. 2.

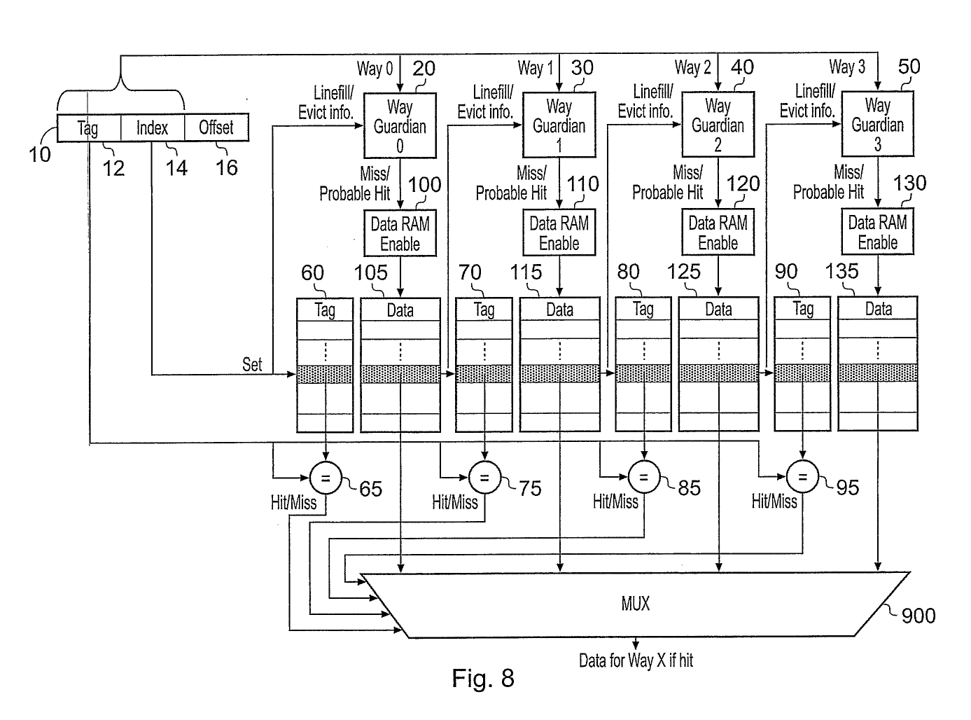

FIG. 8 is a diagram illustrating a cache and associated indication logic in accordance with an alternative embodiment of the present invention. This embodiment is similar to that described earlier with reference to FIG. 2, in that the cache is arranged as a four way set associative cache having one way guardian logic unit associated with each way of the cache. For ease of comparison with FIG. 2, like elements have been identified in both FIGS. 2 and 8 using the same reference numerals. However, in contrast to the embodiment of FIG. 2, the cache illustrated in FIG. 8 is a parallel access cache, where during a lookup procedure the tag arrays and data arrays are accessed at the same time.

As shown in FIG. 8, the index portion 14 of an address 10 is used to identify an entry in each tag array 60, 70, 80, 90 associated with the relevant set, with the tag data in that entry being output to associated comparator logic 65, 75, 85, 95. At the same time, the tag portion 12 and index portion 14 of the address are routed to each of the way guardian logic units 20, 30, 40, 50 to initiate a lookup in those units in the manner discussed earlier with reference to FIG. 2. This results in the generation of an indication which is output from each way guardian logic unit 20, 30, 40, 50 to associated data RAM enable circuits 100, 110, 120, 130. Depending on the timing of the logic it may not be necessary to provide separate data RAM enable circuits as shown, and instead the indications from the way guardian logic units 20, 30, 40, 50 could directly enable or disable the respective data arrays 105, 115, 125, 135.

For any data arrays where the indication identifies a definite miss, those data arrays are disabled and no lookup is performed. However, for any data arrays where the indication identifies a probable hit, a lookup is performed in those data arrays using the index 14 to access the relevant set and the offset 16 to access the relevant data value within the cache line. These accessed data values are then output to the multiplexer 900. Whilst any such data array lookups are being performed, the comparator logic 65, 75, 85, 95 will be comparing the tag values output from the respective tag arrays 60, 70, 80, 90 with the tag portion 12 of the address, and in the event of a match will issue a hit signal to the multiplexer 900.

If one of the comparators 65, 75, 85, 95 generates a hit signal, that is used to cause the multiplexer 900 to output the data value received from the corresponding data array 105, 115, 125, 135. From the above description, it will be seen that in such an embodiment the indications produced by the way guardian logic units can be used to disable any data arrays for which the associated way guardian logic unit determines that the data value is definitely not stored therein, thereby saving cache energy that would otherwise be consumed in accessing those data arrays. Further, in the manner described with reference to FIG. 8, the operation of the way guardian logic units is arranged to have no penalty on cache access time.

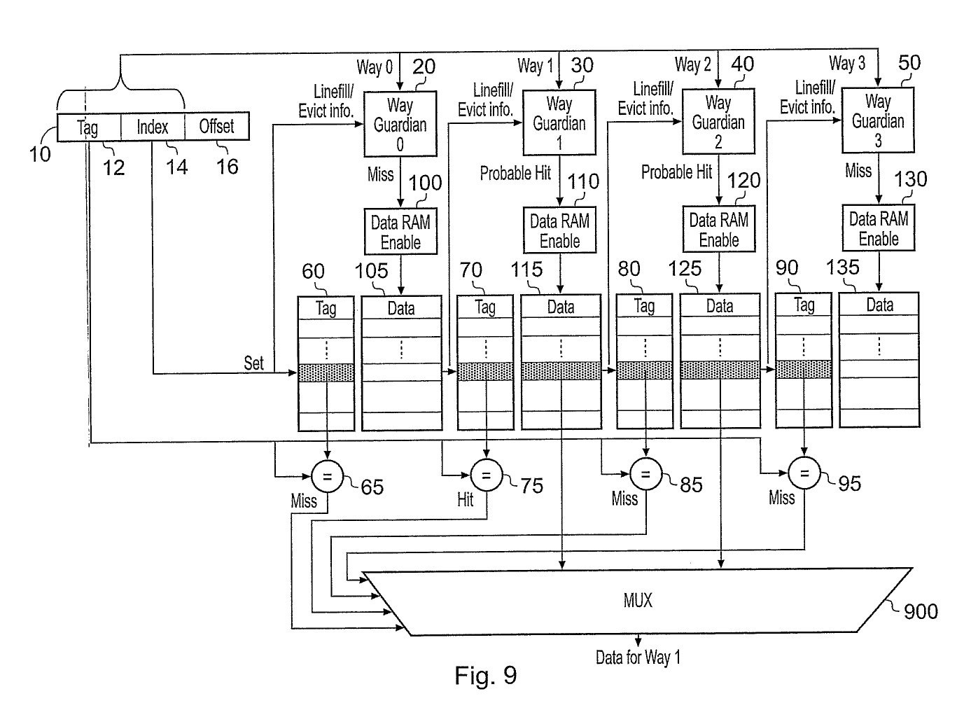

A particular example of the operation of the logic of FIG. 8 is shown in FIG. 9. In this example, the way guardian logic units 30, 40 identify a probable hit, but the way guardian logic units 20, 50 identify a definite miss. As a result, lookups are performed in data arrays 115, 125, but data arrays 105, 135 are disabled. Meanwhile each of the comparators 65, 75, 85, 95 will perform their comparison of the tag values output from the respective tag arrays 60, 70, 80, 90 with the tag portion 12 of the address, and as shown in FIG. 9 this results in comparator 75 detecting a match and generating a hit signal. All other comparators do not detect a match. As a result, multiplexer 900 outputs the data value obtained from data array 115, i.e. the data value found in way 1.

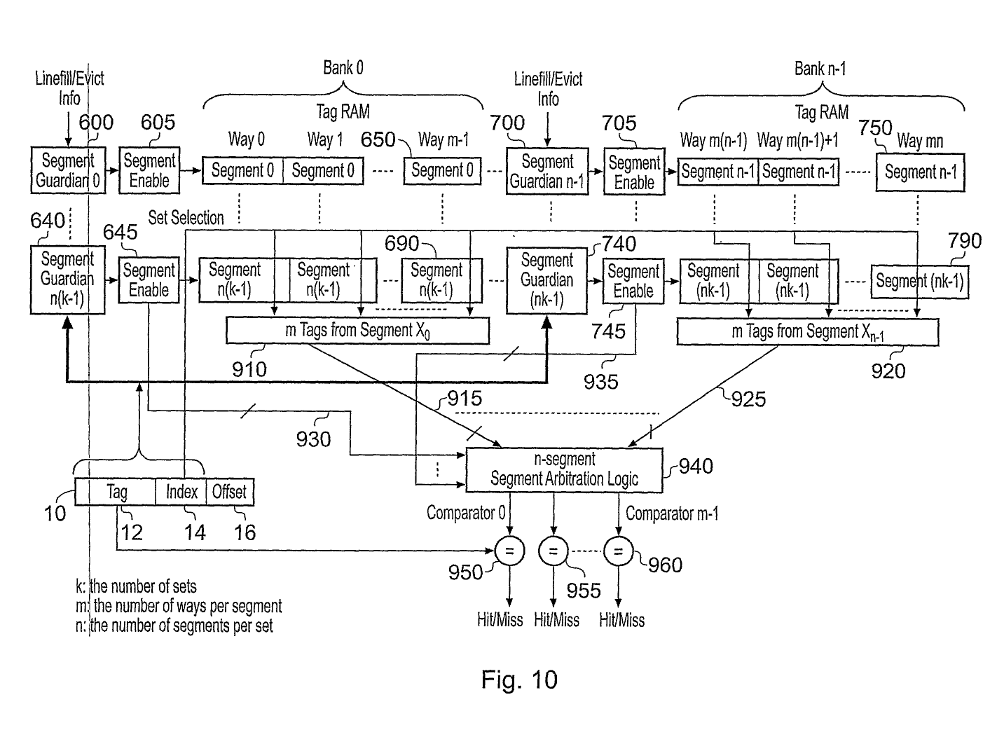

FIG. 10 illustrates an alternative embodiment of the present invention, where instead of providing indication units in association with each way of the cache, indication units are instead provided in association with at least part of each set of the cache. In particular, in this example, each set in the cache is logically partitioned into n segments. Hence, segment zero 650 comprises the tag array entries for set zero in ways zero to m−1, and segment n−1 750 comprises the tag array entries for set zero in ways m(n−1) to mn. Likewise segment n(k−1) 690 and segment nk-1 790 contain the tag array entries of the various ways for set k−1. Each segment has associated therewith segment guardian logic 600, 640, 700, 740, which is used to drive associated segment enable circuitry 605, 645, 705, 745, respectively. As with the way guardian logic unit described in FIG. 2, each segment guardian logic unit maintains guarding data (which in one embodiment is comprised of the counter logic and vector logic discussed earlier) which is maintained based on linefill and eviction information pertaining to the associated segment. Further, for each address 10, the tag portion 12 and index portion 14 are used to reference the segment guardian logic units associated with the relevant set so as to generate an indication which identifies a miss or a probable hit in the associated segment, with this indication being used to either enable or disable the associated segment enable circuitry. The index portion 14 is also routed to the tag array to select the relevant set. Each segment in that associated set, provided its associated segment enable circuitry is enabled, will then output m tag values 910, 920, which will be routed over paths 915, 925 to the segment arbitration logic 940.

The segment arbitration logic 940 also receives over path 930, 935 the segment enable values associated with the relevant segment enable circuitry which, in the event that the segment arbitration logic 940 receives tags from multiple segments, can be used to prioritise one of those segments. The prioritisation may be performed on a sequential or random basis. Alternatively, in one embodiment, prediction logic is used in addition to the indication logic to predict a segment in which the data value may exist, and this is used by the segment arbitration logic to arbitrate a particular segment ahead of another segment. In particular, if one of the segments producing tags input to the segment arbitration logic 940 corresponds with the segment identified by the prediction logic, then the segment arbitration logic 940 is arranged to select that segment.

For the selected segment, the m tags are then output to m comparators 950, 955, 960, which are arranged to compare the tags with the tag portion 12 of the address, resulting in the generation of hit or miss signals from each comparator 950, 955, 960. If a hit is generated by one of the comparators, then this is used to enable the associated data array and cause the relevant data value to be accessed. In the event that all of the comparators produce a miss, then the segment arbitration logic 940 is arranged to re-arbitrate in order to choose another segment that has produced m tags, such that those tags are then routed to the comparators 950, 955, 960. This process is repeated until a cache hit is detected, or all of the multiple segments producing tags have been subjected to the lookup procedure. Depending on the number of segments enabled as a result of the segment guardian lookup, it will be appreciated that the maximum number of segments to be arbitrated between would be “n”, but in practice there will typically be significantly less than n segments due to the segment guardian lookups identifying definite misses in some segments.

By such an approach, the comparator logic 950, 955, 960 can be shared across multiple segments, with the segment arbitration logic 940 selecting separate segments in turn for routing to the comparator logic 950, 955, 960. This hence decreases the cost associated with the comparison logic, albeit at the expense of an increased access time due to the serial nature of the comparison. However, this performance impact may in practice be relatively low, since in many instances there may only be a few segments that are enabled based on the output from the various segment guardian logic units for the relevant set, and accordingly only a few groups of m tags needs to be subjected to comparison by the comparison logic 950, 955, 960.

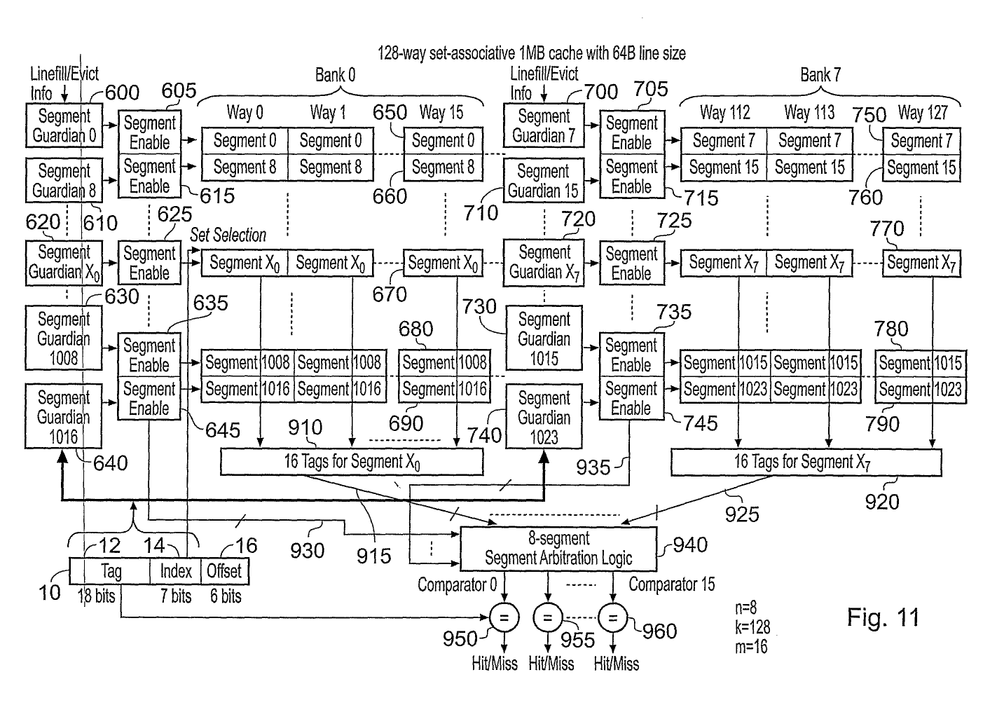

The embodiment of FIG. 10 may be particularly useful in very highly set-associative caches where there are a large number of ways, and accordingly a large number of cache lines in each set. In such instances, significant power savings can be adopted by use of the approach illustrated in FIG. 10. In particular, it has been found that such an approach can offer very high associativity at the dynamic energy costs of much lower set associative caches. For example, a sample associative cache as shown in FIG. 10 may provide the functionality of a 128 way set associative cache with an energy profile and timing characteristics close to a 16 way set associative cache. Such an example is illustrated in FIG. 11, where a 128 way set associative cache has a size of 1 Mb with cache lines of 64 bytes. As can be seen from FIG. 11, n=8 (i.e. there are 8 segments per set), k=128 (i.e. there are 128 sets) and m=16 (i.e. there are 16 ways per segment). As shown in FIG. 11, each of the segments 650, 660, 670, 680, 690, 750, 760, 770, 780, 790 have associated segment guardian logic 600, 610, 620, 630, 640, 700, 710, 720, 730, 740 used to enable or disable associated segment enable circuitry 605, 615, 625, 635, 645, 705, 715, 725, 735, 745, respectively.

In the example given, the index portion 14 of the address identifies the set consisting of segments X₀ to X₇. For each of the at most eight segments that are enabled by their associated segment enable circuitry 625, 725, sixteen tag values are output, one for each way in that segment. If more than one segment produces a set of sixteen tag values, then segment arbitration logic 940 arbitrates between those multiple segments to choose one set of sixteen tag values to be output to the sixteen comparators 950, 955, 960. If a hit is detected by one of those comparators, then a lookup is performed in the data array for the corresponding way in order to access the required data value. In this instance, only 16 tag comparisons will be necessary assuming a hit is detected in the first segment arbitrated, even though there are 128 ways. Hence, significant power savings are achievable using the above technique. Also, cache access timing characteristics can be achieved which are similar to much lower set associative caches.

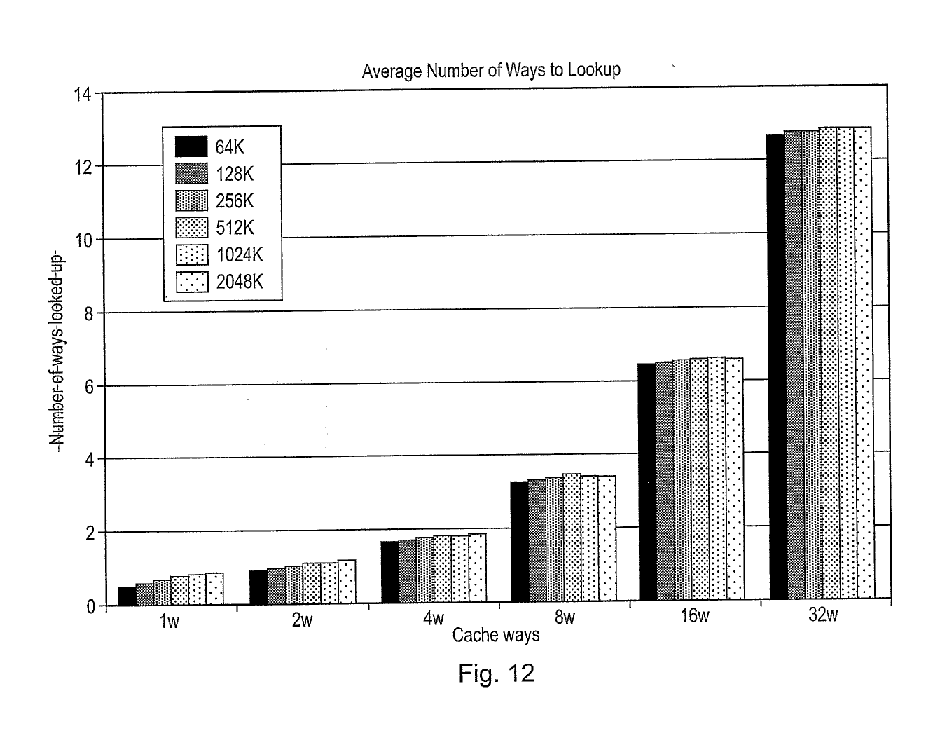

FIG. 12 is a chart illustrating some results obtained when analysing the design of FIG. 2 for caches of different associativity. In particular, to study the performance of the way guardian logic units 20, 30, 40 and 50, 7 SPEC 2000 integer benchmarks were run in relation to a memory hierarchy having a level two cache with sizes of 64 Kbytes, 128 Kbytes, 256 Kbytes, 512 Kbytes, 1 Mbyte and 2 Mbyte. The level one cache size was always considered to be 16 Kbytes for the instruction cache and 16 Kbytes for the data cache. The associativities for the level two cache were varied from a direct mapped cache to a 32 way cache. The number of entries in the counter logic and vector logic of each way guardian logic unit 20, 30, 40 and 50 was chosen to be four times the number of cache sets. The results are shown in FIG. 12. FIG. 12 illustrates the average number of ways that need to be subjected to the lookup procedure for each cache using the way guardian approach of FIG. 2. As can be observed from FIG. 12, for all cache configurations less than 47% of the cache ways need to be subjected to the lookup procedure.

Whilst not explicitly shown in the figures, it is possible to combine the way guardian approach, or more generally segment guardian approach, of embodiments of the present invention, with known prediction schemes. In such embodiments, the indications produced by the various guardian logic units would be used in association with the prediction produced by the prediction logic to determine which segments to subject to the lookup procedure. In particular, the cache may be arranged in the first instance to perform the lookup procedure in respect of any segments identified by both the prediction logic and the segment guardian logic as possibly storing the data value, and in the event of a cache miss in those segments the cache would then be operable to further perform the lookup procedure in respect of any remaining segments identified by the segment guardian logic as possibly storing the data value. Further, if the prediction produced by the prediction logic identified a segment that the segment guardian logic identified as definitely not storing the data value, then the prediction can be ignored to save any power being expended in performing a lookup based on that prediction. By combining the segment guardian approach of embodiments of the present invention with known prediction schemes, it has been found that further power savings can be achieved.

It has been found that the techniques of the present invention enable dynamic power savings to be achieved for every cache access. In particular, significant savings in cache dynamic power can be achieved due to the fact that the guardian logic units use a hash operation to access a bit vector, which consumes much less power than the corresponding tag array that the guardian logic unit is guarding. Because such guardian logic can produce miss indications which are definitive, rather than predictions, this can be used to avoid the lookup procedure being initiated in respect of one or more segments, thereby yielding significant power savings. As discussed earlier with reference to FIG. 12, experiments have shown that when using such guardian logic there is a need on average to check less than 47% of the ways for a variety of n way set associative caches where 2≦n≦32.

Although a particular embodiment has been described herein, it will be appreciated that the invention is not limited thereto and that many modifications and additions thereto may be made within the scope of the invention. For example, various combinations of the features of the following dependent claims could be made with the features of the independent claims without departing from the scope of the present invention.

1. A data processing apparatus comprising:
processing logic for performing a sequence of operations;
a cache level having a plurality of segments for storing data values for access by the processing logic, the processing logic being operable when access to a data value is required to issue an access request specifying an address in memory associated with that data value, and the cache level being operable in response to the address to perform a lookup procedure in parallel in at least a subset of the segments during which it is determined whether the data value is stored in the cache level; and
indication logic operable in response to an address portion of the address to provide, for each of said at least a subset of the segments, an indication as to whether the data value is stored in that segment, the indication logic comprising:
guardian storage for storing guarding data; and
hash logic for performing a hash operation on the address portion in order to reference the guarding data to determine each indication, each indication indicating whether the data value is either definitely not stored in the associated segment or is potentially stored within the associated segment;
the cache level being operable to use the indications produced by the indication logic to affect the lookup procedure performed in respect of any segment whose associated indication indicates that the data value is definitely not stored in that segment.

2. A data processing apparatus as claimed in claim 1, wherein said at least a subset of the segments comprises all segments.

3. A data processing apparatus as claimed in claim 1, wherein the lookup procedure is only performed after the indications have been produced by the indication logic, thereby avoiding the lookup procedure being initiated in respect of any segment whose associated indication indicates that the data value is definitely not stored in that segment.

4. A data processing apparatus as claimed in claim 1, wherein the lookup procedure is initiated prior to the indications being produced by the indication logic.

5. A data processing apparatus as claimed in claim 1, wherein each segment comprises a plurality of cache lines.

6. A data processing apparatus as claimed in claim 1, wherein the cache level is a set associative cache and each segment comprises at least part of a way of the cache level.

7. A data processing apparatus as claimed in claim 6, wherein each segment comprises a way of the cache level.

8. A data processing apparatus as claimed in claim 1, wherein the cache level is a set associative cache and each segment comprises at least part of a set of the cache level.

9. A data processing apparatus as claimed in claim 1, wherein the indication logic implements a Bloom filter operation, the guarding data in the guardian storage comprises a Bloom filter counter array for each segment, and the hash logic is operable from the address portion to generate at least one index, each index identifying a counter in the Bloom filter counter array for each segment.

10. A data processing apparatus as claimed in claim 1, wherein the indication logic comprises a plurality of indication units, each indication unit being associated with one of said segments and being operable in response to the address portion to provide an indication as to whether the data value is stored in the associated segment.

11. A data processing apparatus as claimed in claim 10, wherein each indication unit comprises guardian storage for storing guarding data for the associated segment.

12. A data processing apparatus as claimed in claim 11, wherein:
each guardian storage comprises:
counter logic having a plurality of counter entries, each counter entry containing a count value; and
vector logic having a vector entry for each counter entry in the counter logic, each vector entry containing a value which is set when the count value in the corresponding counter entry changes from a zero value to a non-zero value, and which is cleared when the count value in the corresponding counter entry changes from a non-zero value to a zero value;
the hash logic being operable to generate from the address portion at least one index, each index identifying a counter entry and associated vector entry;
the hash logic being operable whenever a data value is stored in, or removed from, a segment of the cache level to generate from the address portion of the associated address said at least one index, and to cause the count value in each identified counter entry of the counter logic of the associated guardian storage to be incremented if the data value is being stored in that segment or decremented if the data value is being removed from that segment; and
the hash logic further being operable for at least some access requests to generate from the address portion of the associated address said at least one index, and to cause the vector logic of each of at least a subset of the guardian storages to generate an output signal based on the value in each identified vector entry, the output signal indicating if the data value of the access request is not stored in the associated segment.

13. A data processing apparatus as claimed in claim 12, wherein:
the hash logic comprises first hash logic associated with the counter logic and second hash logic associated with the vector logic;
whenever a data value is stored in, or removed from, a segment of the cache level the first hash logic being operable to generate from the address portion of the associated address said at least one index identifying one or more counter entries in the counter logic of the associated guardian storage; and
for at least some access requests the second hash logic being operable to generate from the address portion of the associated address said at least one index identifying one or more vector entries in the vector logic of each of at least a subset of the guardian storages.

14. A data processing apparatus as claimed in claim 11, wherein the hash logic is replicated for each indication unit.

15. A data processing apparatus as claimed in claim 12, further comprising lookup control logic operable in response to said output signal from the vector logic of each said guardian storage to abort the lookup procedure in respect of the associated segment if the output signal indicates that the data value is not stored in that segment.

16. A data processing apparatus as claimed in claim 12, further comprising:
matrix storage for providing the vector logic for all indication units;
the hash logic being operable for at least some access requests to generate from the address portion of the associated address said at least one index, and to cause the matrix storage to generate a combined output signal providing in respect of each indication unit an indication of whether the data value is either definitely not stored in the associated segment or is potentially stored within the associated segment.

17. A data processing apparatus as claimed in claim 1, further comprising:
prediction logic operable in response to an address portion of the address to provide a prediction as to which of the segments the data value is stored in;
the cache level being operable to use the indications produced by the indication logic and the prediction produced by the prediction logic to determine which segments to subject to the lookup procedure.

18. A data processing apparatus as claimed in claim 17, wherein the cache level is operable to perform the lookup procedure in respect of any one or more segments identified by both the prediction logic and the indication logic as possibly storing the data value, and in the event of a cache miss in those one or more segments the cache level being operable to further perform the lookup procedure in respect of any remaining segments identified by the indication logic as possibly storing the data value.

19. A data processing apparatus as claimed in claim 17, wherein the cache level is operable to ignore the prediction produced by the prediction logic to the extent that prediction identifies any segments that the indication logic has identified as definitely not storing the data value.

20. A data processing apparatus as claimed in claim 1, further comprising:
arbitration logic operable, if the indication logic produces indications indicating that the data value is potentially stored in multiple segments, to apply arbitration criteria to select one of said multiple segments;
the cache level being operable to perform the lookup procedure in respect of the segment selected by the arbitration logic;
in the event that that lookup procedure results in a cache miss, a re-try process being invoked to cause the arbitration logic to reapply the arbitration criteria to select an alternative segment from the multiple segments and the cache level to re-perform the lookup procedure in respect of that alternative segment, the re-try process being repeated until a cache hit occurs or all of the multiple segments have been subjected to the lookup procedure.

21. A data processing apparatus as claimed in claim 17, further comprising:
arbitration logic operable, if the indication logic produces indications indicating that the data value is potentially stored in multiple segments, to apply arbitration criteria to select one of said multiple segments;
the cache level being operable to perform the lookup procedure in respect of the segment selected by the arbitration logic;
in the event that that lookup procedure results in a cache miss, a re-try process being invoked to cause the arbitration logic to reapply the arbitration criteria to select an alternative segment from the multiple segments and the cache level to re-perform the lookup procedure in respect of that alternative segment, the re-try process being repeated until a cache hit occurs or all of the multiple segments have been subjected to the lookup procedure;
wherein the arbitration criteria applied by the arbitration logic takes into account the prediction provided by the prediction logic.

22. A cache level for storing data values for access by processing logic of a data processing apparatus, for an access request specifying an address in memory associated with a data value required to be accessed by the processing logic, the cache level being operable to perform a lookup procedure in parallel in at least a subset of the segments during which it is determined whether the data value is stored in the cache level, the cache level comprising:
a plurality of segments for storing the data values, and
indication logic operable in response to an address portion of the address to provide, for each of said at least a subset of the segments, an indication as to whether the data value is stored in that segment, the indication logic comprising:
guardian storage for storing guarding data; and
hash logic for performing a hash operation on the address portion in order to reference the guarding data to determine each indication, each indication indicating whether the data value is either definitely not stored in the associated segment or is potentially stored within the associated segment;
the cache level being operable to use the indications produced by the indication logic to affect the lookup procedure performed in respect of any segment whose associated indication indicates that the data value is definitely not stored in that segment.

23. A method of accessing a cache level used to store data values for access by processing logic of a data processing apparatus, the cache level having a plurality of segments for storing the data values, the method comprising:
for an access request specifying an address in memory associated with a data value required to be accessed by the processing logic, performing a lookup procedure in parallel in at least a subset of the segments during which it is determined whether the data value is stored in the cache level;
in response to an address portion of the address, employing indication logic to provide, for each of said at least a subset of the segments, an indication as to whether the data value is stored in that segment, by:
storing guarding data; and
performing a hash operation on the address portion in order to reference the guarding data to determine each indication, each indication indicating whether the data value is either definitely not stored in the associated segment or is potentially stored within the associated segment; and
using the indications produced by the indication logic to affect the lookup procedure performed in respect of any segment whose associated indication indicates that the data value is definitely not stored in that segment.
